(19) United States
(12) Patent Application Publication
(10) Pub. No.: US 2012/0227816 A1
(43) Pub. Date: Sep. 13, 2012

(54) DYNAMIC GAS BLENDING

(76) Inventors: Xuemei Song, East Amherst, NY (US); Lloyd Anthony Brown, East Amherst, NY (US); Thomas Schulte, Grand Island, NY (US)

(21) Appl. No.: 13/045,174

(22) Filed: Mar. 10, 2011

(51) Int. Cl. F15D 1/00

(52) U.S. Cl. 137/1

(57) ABSTRACT

This invention is directed to various protocols for reprocessing off-spec gas to produce a concentration of off-spec gases to a desired target concentration. A combination of source gases is blended with the off-spec gas. This technique has the effect of enabling relatively small adjustments to the concentration of off-spec gas. Processes are also described that incorporate the blending protocols.

### FIELD OF THE INVENTION

This invention relates to a method for re-blending off-spec gases.

### BACKGROUND OF THE INVENTION

The blending of two or more gases to form a predetermined homogeneous gaseous mixture is fundamental to many industrial processes. As an example, the solar and LCD industries currently rely on the use of dilute dopant gas mixtures for doping semiconductor materials, and the like.

The semiconductor industry continues to maintain an ever-increasing demand for ultra-high purity gases employed in a variety of fabrication processes. Many of the process gases utilized within the semiconductor industry are hazardous. By way of example, arsine, germane, phosphine, and silane are commonly employed gases within the semiconductor industry and are commonly referred to as active gases (“active gas”). These active gases are routinely blended with a balance source gas (“balance gas”) to create a resultant gas mixture (“product gas”) that can be used for a variety of processes in the semiconductor and solar manufacturing industries.

The product gas mixture for use in the semiconductor industry requires not only ultra-high purity, but a target composition that is suitable for downstream processing. Compared to other gas processing industries, acceptable compositional tolerance limits within the semiconductor industry are narrow. The correct percentage of each gas component in the product gas typically may be within a plus or minus 3-10% tolerance of the target concentration. The specific tolerance range depends on the particular active gas component that is being blended.

As a result of the narrow tolerance, even a slight deviation in the gas composition can lead to non-conformant product gas, which will be referred to herein as “off-spec product gas” or “off-spec gas”. The off-spec product gas has an off-spec concentration that is undesirable because the off-spec product gas cannot be subsequently used downstream in processes, such as, for example, chemical vapor deposition, atomic layer deposition, or physical vapor deposition. As a result, the off-spec product gas can lead to toxic products, increased waste gas and increased operational costs. Furthermore, because the off-spec product gas consists of gaseous mixtures that are typically hazardous to humans and the environment, appropriate abatement systems for disposal of the waste gases must be utilized. In one example, the hazardous waste gas is vented to a scrubber. This undesirably increases material and operational costs, while decreasing the utilization of the active and balance gases.

Accordingly, product gas mixtures within a prescribed tolerance range are needed on a consistent basis to reduce the amount of waste gas that is potentially generated. As previously mentioned, even a slight deviation from the target concentration may lead to off-spec product gas. The composition of the off-spec product gas may fall marginally outside of the upper or lower concentration limit. In this scenario, only a relatively small amount of active gas or balance gas is required to concentrate or dilute the off-spec gas into the acceptable concentration range. However, to this end, the production flow control devices responsible for regulating the flow of the active and balance gases typically may not have the accuracy and precision to regulate at the much lower required flow rate. The required flow rate to adjust the off-spec concentration can be at or outside the lower limit capability of the production flow control devices. As a result, the production flow control devices may be unable to regulate such a relatively small amount of gas flow to adjust the off-spec concentrations of the off-spec product gas mixtures into an acceptable concentration range suitable for downstream processing.

The ability to correct the off-spec concentrations on an uninterrupted basis which is safe and reliable and at the same time reduces waste gas and product variation is desirable. Other aspects of the present invention will become apparent to one of ordinary skill in the art upon review of the specification, drawings, and claims appended hereto.

### SUMMARY OF THE INVENTION

The present invention utilizes a protocol for dynamically gas blending a combination of the balance gas, active gas, and recycled off-spec gas. This technique has the effect of enabling relatively small adjustments to the concentration of the off-spec product gas, as compared to the related art, by regulating flow rates of the balance gas and active gas to be re-blended with a recycled stream of the off-spec gas to achieve a target concentration.

In accordance with one aspect of the invention, the dynamic gas blending protocol recycles the off-spec gas mixture upstream of a mixer. The off-spec gas mixture includes a gaseous component at an off-spec concentration. Active gas is regulated at a flow rate using a first flow control device. The active gas includes the gaseous component of the off-spec mixture, but at a concentration that is greater than that of the off-spec mixture concentration. Balance gas is regulated at a flow rate using a second flow control device. The off-spec gas mixture is re-blended with the active and balance gases to create a resultant mixture at the target concentration.

In accordance with another aspect of the present invention, a dynamic gas blending process is provided. The off-spec product gas mixture is recycled upstream of a mixer at a recycled flow rate. The off-spec gas mixture includes a gaseous component at an off-spec concentration. A flow rate of balance gas is regulated using a first flow control device. The off-spec gas mixture is re-blended with the balance gas. This re-blending causes the off-spec gas mixture to be diluted to a concentration that is less than the off-spec concentration. Next, active gas is regulated at a flow rate using a second flow control device. The active gas includes the gaseous component of the off-spec gas at a concentration that is greater than that contained in the off-spec concentration. This blending causes the off-spec gas mixture to be concentrated from the diluted concentration to the target concentration.

In accordance with yet another aspect of the present invention, a dynamic gas blending method for adjusting a concentration of an off-spec gas mixture to a target concentration is provided. An off-spec gas mixture is recycled upstream of a mixer. The off-spec gas mixture comprises a gaseous component at an off-spec concentration. Active gas is regulated at a flow rate using a first flow control device. The active gas includes the gaseous component of the off-spec gas at a concentration greater than that contained in the off-spec concentration. The off-spec gas is re-blended with the active gas. This blending causes the off-spec gas mixture to be concentrated to a concentration that is greater than the off-spec concentration. Next, balance gas is regulated at a flow rate using a second flow control device. This blending causes the off-spec gas mixture to be diluted to the target concentration to create a resultant product mixture.

### BRIEF DESCRIPTION OF THE DRAWINGS

The objects and advantages of the invention will be better understood from the following detailed description of the preferred embodiments thereof in connection with the accompanying figures wherein like numbers denote same features throughout and wherein:

FIG. 1 shows a process flow diagram incorporating the principles of the inventive blending protocol; and

FIG. 2 shows an alternative process flow diagram incorporating the principles of the inventive blending protocol.

### DETAILED DESCRIPTION OF THE INVENTION

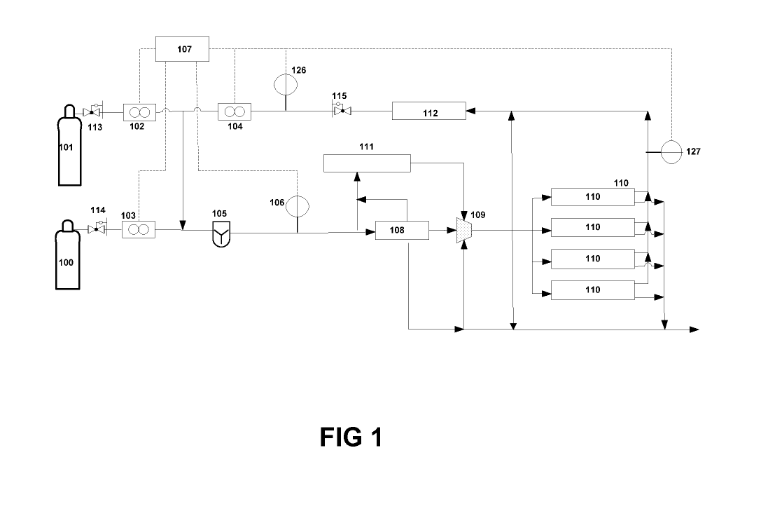

As used herein, all concentrations are expressed as volumetric percentages. One aspect that embodies the principles of the present invention will now be described. FIG. 1 shows a process flow diagram of an on-site dynamic blending system. As will be explained, the system of FIG. 1 is designed to dynamically blend gas mixtures with the capability to re-blend off-spec gas by recycling a flow rate of off-spec gas upstream of a mixer with a regulated flow rate of balance gas and active gas.

The supply gas sources for the balance gas and the active gas are designated as balance gas source 100 and active gas source 101, respectively. Each of the two gas sources 100 and 101 may be contained in a variety of different vessels such as, by way of example, ISO containers, drums, ton containers, tubes, or cylinders.

H₂ or other gases may be used as the balance gas contained in balance gas source 100. A variety of active gas sources as known in the art may be utilized, such as, for example, phosphine (PH₃), arsine (AsH₃), trimethylboron (B(CH₃)₃), silane (SiH₄), diborane (B₂H₆), disilane (Si₂H₆), germane (GeH₄), boron trifluoride (BF₃), boron trichloride (BCl₃), fluorine (F₂), xenon (Xe), argon (Ar), helium (He) and krypton (Kr).

The supply pressures of the active gas source 101 and the balance gas source 100 may be controlled by corresponding pressure regulators. FIG. 1 shows that pressure regulators 113 and 114 are utilized for controlling the delivery pressure of the active gas and balance gas from their respective gas sources 101 and 100. The pressure regulators 113 and 114 are designed to lower and maintain the delivery pressures of the active and balance source gases from their corresponding supply sources 101 and 100.

Downstream of the pressure regulators 113 and 114 are gas flow controlling devices 102 and 103 which control the flow rates of the active and balance gases through the process piping. Gas flow controlling device 104 controls the flow rate of the recycled off-spec gas mixture. Various gas flow control devices as known in the art may be used, such as, for example, mass flow meters, orifices, and adjustable valves. Preferably, and as shown in FIG. 1, the gas flow metering devices are mass flow controllers.

The blending system also includes a mixer, into which active gas and balance gas are dynamically blended or the off-spec gas is re-blended with active gas and/or balance gas therein to adjust the concentration of the off-spec gas to a target concentration. The term “mixer” as used herein refers to any type of mixing device known in the art to blend gaseous components. Possible mixing devices include, but are not limited to, mixing manifolds, mixing chambers with impellers, and conduits with baffles. FIG. 1 shows a gas mixer 105 that is located downstream of the gas flow controlling devices 102, 103 and 104 to blend the gases.

The dynamic gas blending process will now be explained. It should be understood that the concentrations, flow rates and gases described herein are intended to merely illustrate the principles of the invention. The blending system of FIG. 1 may also produce PH₃ gas mixtures at lower or higher flow rates, depending on the downstream usage requirement. Still referring to the process configuration of FIG. 1, a design flow rate of 100 slpm of product gas having a target composition of 1% PH₃ and 99% H₂ is desired to be blended. In this example, the allowable concentration of the PH₃ product gas mixture can range from as low as 0.97% to as high as 1.03% to be considered product gas that is within specification for downstream processing. Pressure regulators 113 and 114 lower the pressure of the corresponding active gas and the balance gas from their respective gas sources 101 and 100. Mass flow controller 102 has a flow capacity of 2 slpm and is preferably set at about 50% of its capacity to regulate 1 slpm of PH₃ from active gas source 101. Mass flow controller 103 has a flow capacity of 200 slpm and is preferably set at about 50% of its capacity to regulate 99 slpm of H₂ from balance gas source 100. 1 slpm of PH₃ gas mixes with 99 slpm of H₂ gas, as shown in FIG. 1. The resultant stream is fed into mixer 105 which blends the PH₃ and H₂ gasses.

As the PH₃ and H₂ gases flow through the mixer 105, the gases are blended. The blended gas stream exits the mixer 105 and is then sampled by gas analyzer 106. The gas mixture entering the gas analyzer 106 is preferably of uniform composition. Gas analyzer 106 measures the concentration of the blended gas stream and then sends a signal to the controller 107 which then sends a signal to mass flow controller 102 and/or 103 to make appropriate adjustments to the flow rates of PH₃ and/or H₂ from their respective gas sources 101 and 100. This feedback control loop procedure is repeated throughout the dynamic gas blending process to monitor the gas mixture and make adjustments to the mass flow controllers 102 and/or 103, if required, to ensure that the PH₃ concentration is within the acceptable ±3% of the target PH₃ concentration. Accordingly, the mass flow controllers 102 and/or 103 are dynamically adjusted with a closed-loop feedback controller 107 that is capable of controlling the blend accuracy of the PH₃ and H₂ in real-time.

If the analyzer 106 detects that the measured PH₃ concentration is within acceptable tolerance limits, the resultant gas mixture may be directed to surge vessel 108. The surge vessel 108 acts as a storage reservoir which avoids gas feed problems to the compressor 109. The surge vessel 108 absorbs process variations, such as, for example, mixture concentration, pressure, and flow rate. FIG. 1 shows that a compressor 109 is used to pressurize and compress the gas mixture from surge vessel 108 to the product storage vessels 110.

After a storage vessel 110 has been filled, a sample of the product gas mixture may be directed to gas analyzer 127 to further qualify the gas mixture concentration within the filled vessel 110. Sampling product gas from a filled storage vessel 110 assures that the PH₃ concentration is within acceptable tolerance before the product gas is sent to downstream processing. The pressure of the product gas from the filled storage vessel 110 is regulated down, if required, to meet the pressure requirement of the gas analyzer 127. If the product gas is measured by analyzer 127 to be out of specification, then the product gas is considered off-spec product gas which can be directed to either recycle vessel 112 for remix later or the blending system for remix to achieve the desired concentration of the gas mixture. FIG. 1 shows the blending system is equipped with a collection vessel 111. Preferably, the collection vessel 111 is set to the lowest pressure in the system to allow off-spec gases from any part of the system to be routed therein without utilizing a pump or other pressurized source. For example, the relatively small amounts of product gases from the storage vessels 110 that are directed to the gas analyzer 127 for sampling may subsequently be routed to the collection vessel 111.

Other instances may arise in which waste or off-spec gas is generated. For example, off-spec gas may be initially generated during start-up of the gas blending process of FIG. 1 when the H₂ and PH₃ gases are initially mixed. When PH₃ and H₂ are initially blended in mixer 105, the resultant concentration may be off-spec due to inherent delays in the response of the controller 107 and/or the other system components of FIG. 1. Accordingly, this off-spec gas generated during start-up may be routed to the collection vessel 111. In yet another scenario, residual or waste gas in the manifold piping may be routed to the collection vessel 111 during maintenance or any other issues. The ability of the present invention to capture all of the waste gas and off-spec gas eliminates the need to vent gas, which can increase material costs. Further, the present invention eliminates the need to implement an abatement system to discard the active gases, which increases the operation of the gas blending process.

All of the captured waste gas and off-spec gas from the process of FIG. 1 can be adjusted to product gas. FIG. 1 shows the blending system is equipped with a recycle vessel 112, which collects any waste and off-spec gas from collection vessel 111, surge vessel 108 or storage vessels 110. The waste gas and off-spec gas from the collection vessel 111, surge vessel 108 or storage vessels 110 may be directed or compressed to the recycle vessel 112 for re-blending at a later time. Accordingly, it should be understood that the stream of off-spec gas that is recycled for re-blending may include waste/residual gases.

Alternatively, since the pressure of the storage vessels 110 is relatively high compared to the other vessels, these gases can bypass recycle vessel 112 and be recycled directly for re-blending to adjust the off-spec concentration to the target concentration by equipping a line from any of the storage vessels 110 to the inlet of the pressure regulator 115.

The flow rate of the recycle stream of the off-spec gas mixture may be regulated with mass flow controller 104. FIG. 1 shows that before the recycled stream is re-blended with PH₃ and/or H₂ gas, a gas analyzer 126 may measure the concentration of the recycle stream. The analyzer 126 then sends a signal to controller 107, which takes into account the flow rate and off-spec PH₃ concentration of the recycled stream of off-spec gas to potentially adjust the PH₃ mass flow controller 102 and/or the H₂ mass flow controller 103 to achieve a target concentration of 1% PH₃ in the resultant gas mixture. In response to the controller 107, flow rates of PH₃ and H₂ are regulated from corresponding flow controllers 102 and 103. The PH₃ and/or H₂ from respective gas sources 101 and 100 are mixed with the recycled off-spec gas mixture upstream of mixer 105. The gases are then re-blended in mixer 105. Gas analyzer 106 samples the re-blended mixture to confirm if the off-spec mixture now has a PH₃ concentration within acceptable tolerance limits.

In an alternative embodiment, a desired flow rate of the recycled off-spec gas can be sent directly for re-blending with PH₃ and/or H₂ gas without gas analyzer 126 measuring the concentration of the off-spec gas mixture. The concentration of the re-blended gas may be controlled by simply adjusting the flow rates of PH₃ and/or H₂ based on the feedback from the analyzer 106. This is also preferably the case if the recycle stream is off-spec product gas from storage vessel 110, as gas analyzer 127 has sampled the concentration of PH₃ from storage vessel 110 prior to the off-spec gas mixture being recycled for re-blending.

The dynamic gas blending system may include multiple storage vessels 110 depending on the usage and downstream process requirements. As shown in FIG. 1, the dynamic gas blending system is equipped with multiple storage vessels 110. The vessels 110 may be configured to continuously supply product gas mixtures downstream from each of the vessel 110. When one of the vessels 110 becomes empty, the process of FIG. 1 can be configured to switch to another vessel 110 and continue to supply product gas mixture downstream without supply interruption. The empty storage vessel 110 detected as empty can start to be filled.

Preferably, at least three storage vessels 110 are utilized. The vessels 110 may be arranged so that a first vessel 110 is filled and on-line, a second vessel 110 is under fill and real-time analysis and a third vessel 110 is empty and ready to be filled. If the gas mixture in the second vessel 110 under fill and analysis is determined to be off-spec by analyzer 127, having the third vessel empty allows the off-spec product from the second vessel 110 under real-time analysis to be recycled for dynamic gas re-blending while the third vessel 110 begins to be filled with product gas that is being re-blended. Alternatively, the off-spec gas from the second vessel 110 may be directed into the recycle vessel 112 for later re-blending, as described above.

In another embodiment, at least four storage vessels 110 may be used with three of the vessels 110 under the same status (i.e., “on-line”, “being filled”, “empty”) as that mentioned above. The fourth vessel 110 is configured so that it is filled, qualified and ready to supply downstream. The arrangement of a first vessel on-line while the fourth vessel 110 is ready to supply downstream allows uninterrupted downstream supply to a customer. Depending on the usage and volume of the vessels 110, instead of one vessel, one group of vessels may be filled, analyzed and supplied simultaneously in accordance with the above described procedure. This method of using multiple storage vessels results in quality assurance and maintenance of product throughput.

Alternatively, the product gas mixture may be supplied directly to the process without the use of storage vessels 110, or the storage vessels 110 may be used as backup in the event that the blending system is off-line for maintenance, gas resupply, and/or other reasons. The blending system may also be used to fill cylinders or containers which can be transported to the customer's location and used as mix gas supply sources. Since the product gas can be supplied from the blending system directly or from multiple storage vessels 110 in which the concentration of the product gas in each vessel 110 is verified independently, the system allows for the incremental addition of storage vessels 110 without interruption of supply.

Although the embodiment of FIG. 1 is shown equipped with a collection vessel 111 and a recycle vessel 112, the blending system may also be implemented without a dedicated collection vessel 111 and/or recycle vessel 112. In an alternative embodiment, the gas mixture in the storage vessel 110 is analyzed after having been filled. If the gas mixture is not within specification, it may be routed from storage vessel 110 directly to the blending system for re-blending in accordance with the dynamic blending process described above.

The setup shown in FIG. 1 is also equipped with analyzers 106, 126 and 127. Analyzer 106 is used to monitor and control the concentration of product, whereas analyzers 126 and 127 are used to measure the concentration of mixtures from recycle vessel 112 and storage vessel(s) 110, respectively. Fewer analyzers may also be utilized in the gas blending process. In one example, analyzer 106 may be used to analyze all of the gas streams by configuring sample lines from the vessels to the analyzer 106.

In some cases, even though the gas is out of specification, the off-spec gas concentrations may not deviate far from the target concentration. As a result, the flow rates required to adjust the off-spec concentration to the target concentration using either the active gas mass flow controller 102 or the balance gas mass flow controller 103 is often less than or near a lower flow rate operating limit for each of the mass flow controllers 102 and 103. For example, if the PH₃ off-spec concentration is 0.96%, the flow rate of pure off-spec PH₃ gas required to increase the off-spec PH₃ concentration to a target concentration of 1% may fall below the lower flow rate operating limit of the 0-2 slpm PH₃ mass flow controller 102 that is being utilized in FIG. 1. In other words, the required flow rate of the PH₃ mass flow controller 102 would be below 2% of its full scale. Generally speaking, mass flow controllers cannot accurately regulate below 2% of their full scale.

In another example, if the PH₃ off-spec concentration is 1.04%, the flow rate of H₂ gas required to decrease the off-spec PH₃ concentration of PH₃ from 1.04% to 1% may fall below the lower flow rate operating limit of the 0-200 slpm H₂ mass flow controller 103 (i.e., fall below 2% of its full scale) that is being utilized in the gas blending process of FIG. 1.

Accordingly, fine-tuned adjustments of the PH₃ concentration may not be possible by a single set of flow control devices. The on-line production gas flow control devices typically will not possess the sensitivity to accurately and precisely meter gas in the requisite small proportions. Although a second set of flow control devices could be added to the gas blending process of FIG. 1 to handle the lower flow rates, this adds cost and complexity to the process. Further, the second set of flow control devices may not be able to accommodate off-spec gas flow rates which may vary beyond the flow rate capabilities of the second set of flow controllers if the off-spec gas concentrations deviate far from the target concentration.

The blending protocol for adjusting recycled off-spec gas to a target concentration will now be explained in accordance with an embodiment of the invention. The present invention recognizes that the use of the active and balance gases at regulated flow rates to adjust a desired flow rate of the off-spec gas can fine-tune the off-spec concentration using the on-line mass flow control devices that are operated on a production basis. In all of the Examples 1-16 to be described in Tables 1-4, the flow rates of PH₃ active gas are advantageously regulated with the production 0-2 slpm PH₃ mass flow controller, and the flow rates of H₂ balance gas are advantageously regulated with the production 0-200 slpm mass flow H₂ controller. As a result, there is no need to re-blend the recycled off-spec gas with active gas and balance gas that are regulated with another set of mass flow controllers.

Table 1 depicts four examples of a gas blending protocol embodying the principles of the present invention. As previously mentioned, all concentrations herein are expressed as volumetric percentages. In each of the examples, 10 slpm of the off-spec gas is re-blended with a regulated flow rate of PH₃ active gas and H₂ balance gas to achieve a resultant target concentration of 1% PH₃. Examples 1-4 illustrate the correction of various off-spec concentrations of PH₃ with calculated flow rate values of PH₃ active gas and H₂ balance gas. Example 1 shows that 10 slpm of 0.5% off-spec PH₃ gas mixture is re-blended with 0.95 slpm of pure PH₃ active gas and 89 slpm of H₂ balance gas to achieve 99.95 slpm of a resultant product gas mixture having a 1% target concentration of PH₃. Example 2 shows that 10 slpm of 0.96% off-spec PH₃ gas mixture is re-blended with 0.91 slpm of pure PH₃ active gas and 89 slpm of H₂ balance gas to achieve 99.91 slpm of a resultant product gas mixture having a 1% target concentration of PH₃. Example 3 shows that 10 slpm of 1.04% off-spec PH₃ gas mixture is re-blended with 0.90 slpm of pure PH₃ active gas and 89 slpm of H₂ balance gas to achieve 99.90 slpm of a resultant product gas mixture having a 1% target concentration of PH₃. Example 4 shows that 10 slpm of 1.50% off-spec PH₃ gas mixture is re-blended with 0.85 slpm of pure PH₃ active gas and 89 slpm of H₂ balance gas to achieve 99.85 slpm of a resultant product gas mixture having a 1% target concentration of PH₃. The re-blending of Examples 1-4 can be carried out in mixer 105 as described above and shown in FIG. 1.

Examples 1-4 show that the flow rates of active gas PH₃ and balance gas H₂ do not vary significantly from the production flow rates of 1 slpm and 99 slpm, respectively. Accordingly, the on-line 0-2 slpm mass flow controller used on a production basis for regulating the flow rate of pure PH₃ active gas can also be used when correcting the off-spec concentration. Similarly, the on-line 0-200 slpm mass flow controller used on a production basis for regulating the flow rate of H₂ balance gas can also be used when correcting the off-spec concentration. Additionally, the blending protocol can handle a wide range of off-spec concentrations as shown in Examples 1-4 to range from 0.5% to 1.50% PH₃. It should be understood that the re-blending protocol shown in Table 1 can handle other off-spec concentrations.

Advantageously, no switching of mass flow controllers is required to re-blend the off-spec gas, and the re-blending produces a resultant stream at substantially the desired product flow rate of about 100 slpm. Therefore, the method of remixing the off-spec gas by introducing both active gas and balance gas makes the control more accurate and precise without any decrease in product flow rate. The process is also simplified because of the ability to use the same production mass flow controllers for regulating PH₃ active gas and H₂ balance gas when correcting the off-spec concentrations of the off-spec gas.

TABLE 1

| 1-Step Blending Protocol | Example 1 | Example 2 | Example 3 | Example 4 |
|---|---|---|---|---|
| Concentration of PH₃ in | 0.5 | 0.96 | 1.04 | 1.50 |
| Off-Spec Gas (%) | | | | |
| Flow rate of PH₃ in Off- | 10 | 10 | 10 | 10 |
| Spec Gas (slpm) | | | | |
| Flow rate of PH₃ active | 0.95 | 0.91 | 0.90 | 0.85 |
| gas (slpm) | | | | |
| Flow rate of H₂ balance | 89 | 89 | 89 | 89 |
| gas (slpm) | | | | |

The present invention can accommodate a wide range of flow rates of the off-spec gas. By way of example, Table 2 illustrates that the off-spec gas flow rate can be increased from 10 slpm, as was used in Table 1, to about 100 slpm. The higher flow rate may be desirable to correct the off-spec gas concentration in a shorter time period, without presenting any process challenges. Table 2 illustrates the required flow rates for re-blending various off-spec concentrations to a target concentration of about 1% PH₃ when the off-spec flow rate is about 100 slpm.

TABLE 2

| 1-Step Blending Protocol | Example 5 | Example 6 | Example 7 | Example 8 |
|---|---|---|---|---|
| Concentration of PH₃ in | 0.5 | 0.96 | 1.04 | 1.50 |
| Off-Spec Gas (%) | | | | |
| Flow rate of PH₃ in Off- | 100 | 100 | 100 | 100 |
| Spec Gas (slpm) | | | | |
| Flow rate of PH₃ active | 1.49 | 1.034 | .95 | .48 |
| gas (slpm) | | | | |
| Flow rate of H₂ balance | 98 | 98 | 98 | 98 |
| gas (slpm) | | | | |

Specifically, Example 5 shows that 100 slpm of 0.5% off-spec PH₃ gas mixture is re-blended with 1.49 slpm of pure PH₃ active gas and 98 slpm of H₂ balance gas to achieve 199.49 slpm of a resultant product gas mixture having a 1% target concentration of PH₃. Example 6 shows that 100 slpm of 0.96% off-spec PH₃ gas mixture is re-blended with 1.034 slpm of pure PH₃ active gas and 98 slpm of H₂ balance gas to achieve 199.034 slpm of a resultant product gas mixture having a 1% target concentration of PH₃. Example 7 shows that 100 slpm of 1.04% off-spec PH₃ gas mixture is re-blended with 0.95 slpm of pure PH₃ active gas and 98 slpm of H₂ balance gas to achieve 198.95 slpm of a resultant product gas mixture having a 1% target concentration of PH₃. Example 8 shows that 100 slpm of 1.50% off-spec PH₃ gas mixture is re-blended with 0.48 slpm of PH₃ active gas and 98 slpm of H₂ balance gas to achieve 198.48 slpm of a resultant product gas mixture having a 1% target concentration of PH₃. As with Examples 1-4, the re-blending can be carried out in mixer 105 as described above and shown in FIG. 1. Table 2 demonstrates that the re-blending can occur at higher throughputs (e.g., about 200 slpm of re-blended product gas mixture) than the product flow rate (e.g., 100 slpm of product gas mixture).

In all of the examples utilizing the inventive blending protocol, a controller (e.g., controller 107 of FIG. 1) may receive an output signal from a gas analyzer (e.g., analyzer 106 of FIG. 1) that measures the re-blended off-spec concentration. The controller performs a real-time mass balance calculation to determine the required flow rates. The controller then transmits an output signal to the active and/or balance gas mass flow controllers (e.g., mass flow controllers 102 and 103 of FIG. 1) for regulating the appropriate flow rates of gases for the re-blending of the off-spec gas.

It should be understood that the blending protocol may vary the flow rates of the H₂ balance gas, the PH₃ active gas or a combination thereof using the corresponding on-line production flow controllers to achieve correction of various off-spec concentrations over a wide range of flow rates of the off-spec gas. The re-blending occurs in accordance with the dynamic blending process as described above.

In another embodiment of the present invention, as an alternative to re-blending the off-spec gas with both active gas and balance gas simultaneously, as shown above in Tables 1 and 2, the off-spec gas may be concentrated first with active gas and then diluted to the desired concentration with balance gas. This two-step re-blending protocol may be implemented as follows. Off-spec gas is initially concentrated by introducing active gas (e.g., PH₃) into a recycle vessel where the off-spec gas is temporarily stored. The amount of active gas introduced into the recycle vessel is controlled based on the concentration and quantity of the off-spec gas therein. After concentrating the off-spec gas with active gas, the concentrated off-spec mixture is introduced into a mixer where it mixes with balance gas (e.g., H₂) to achieve a target concentration. The recycle vessel may be configured with optional internal mixers for mixing the off-spec gases with active gas therein to facilitate the subsequent re-blending of the concentrated off-spec gas mixture with balance gas (e.g., H₂) within the mixer.

The two-step protocol may alternatively be implemented by flowing the off-spec gas and the active gas through a first mixer and then storing the mixture in a vessel. Next, the concentrated off-spec mixture is introduced from the vessel into a second main mixer where it is re-blended with the balance gas to achieve the target concentration.

Table 3 provides Examples 9-12 that utilize a two-step re-blending protocol to adjust the off-spec concentration. In Examples 9-12, the off-spec gas mixture is first concentrated to 10% and then diluted to the target concentration of 1%.

Example 9 shows that the off-spec gas mixture to be corrected has an off-spec PH₃ concentration of 0.5%. The flow rate of the off-spec gas is about 10 slpm. 10 slpm of the off-spec gas mixture is re-blended with 1.06 slpm of pure PH₃ active gas. As a result, the off-spec concentration of PH₃ is concentrated to about 10%. 10 slpm of this 10% PH₃ mixture is then diluted with 90 slpm of pure H₂ balance gas to reduce the concentration from 10% to the target concentration of 1%.

TABLE 3

| | | | Example | Example | Example |
|---|---|---|---|---|---|
| 2-Step Blending Protocol | | Example 9 | 10 | 11 | 12 |
| Concentration of PH₃ in Off-spec | | 0.5% | 0.96% | 1.04% | 1.50% |
| mixture | | | | | |
| Step1: Concentrate | Flow rate of Off- | 10 | 10 | 10 | 10 |
| to 10% PH₃ | spec PH₃ mixture | | | | |
| | (slpm) | | | | |
| | PH₃ (slpm) | 1.06 | 1.00 | .99 | 0.94 |
| Step2: | 10% PH₃ mixture | 10 | 10 | 10 | 10 |
| Dilute to 1% PH₃ | (slpm) | | | | |
| | H₂ (slpm) | 90 | 90 | 90 | 90 |

Example 10 shows that the off-spec gas mixture to be corrected has an off-spec PH₃ concentration of 0.96%. 10 slpm of this off-spec gas mixture is re-blended with 1.00 slpm of pure PH₃ active gas to concentrate the mixture from 0.96% to about 10%. Thereafter, 10 slpm of the 10% PH₃ mixture is diluted with 90 slpm of pure H₂ balance gas to reduce the concentration from about 10% to the target concentration of 1%.

Example 11 shows that the off-spec gas mixture to be corrected has an off-spec PH₃ concentration of 1.04%. 10 slpm of the off-spec gas mixture is re-blended with 0.99 slpm of pure PH₃ active gas to concentrate the mixture from 1.04% to about 10%. Thereafter, 10 slpm of the 10% PH₃ mixture is diluted with 90 slpm of pure H₂ balance gas to attain the target concentration of 1%.

Example 12 shows that the off-spec gas mixture to be corrected has an off-spec PH₃ concentration of 1.50%. 10 slpm of this off-spec gas mixture is re-blended with 0.94 slpm of pure PH₃ active gas to concentrate the mixture from 1.50% to about 10%. Thereafter, 10 slpm of the 10% PH₃ mixture is diluted with 90 slpm of pure H₂ balance gas to attain the resultant mixture of 1%.

In each of the Examples 9-12, the required flow rates of pure PH₃ active gas and H₂ balance gas can be regulated using the production mass flow controllers. The required flow rates are within the optimal operating window of the corresponding mass flow controllers. Although Table 3 concentrates the off-spec gas mixture to about 10%, it should be understood that the present invention contemplates other concentration levels. For example, step 1 of the blending protocol may involve concentrating the off-spec gas mixture to 50% or 90%. The exact concentration level for the two-step blending protocol may depend on various factors, including, for example, the desired flow rates and treatment time.

In yet another embodiment of the present invention, if there is a need to limit the areas where a high concentration of the active gas is present, the two-step blending protocol may be varied so that the off-spec gas mixture is first diluted with H₂ balance gas followed by blending the diluted mixture with pure PH₃ active gas to create the final mixture of the product gas. The dilution step may occur in a similar manner as described above with respect to concentrating the off-spec gas with active gas (i.e., the dilution occurs in a recycle vessel or a mixer).

Table 4 provides Examples 13-16 in which this two-step blending protocol is implemented. In all of the Examples, the off-spec gas is first diluted to 0.25% and then concentrated to the target concentration of 1%. Because each of the off-spec gas mixtures initially attains a diluted concentration level of 0.25%, the flow rates of the diluted mixture and the pure PH₃ active gas utilized in the second step to increase the concentration from 0.25% to 1% are the same. Specifically, in each of Examples 13-16, the concentration step (i.e., step 2) involves blending 99 slpm of the diluted off-spec mixture with 0.75 slpm of pure PH₃ active gas. The existing production mass flow controllers can be used in steps 1 and 2 to correct the off-spec concentrations. Examples 13-16 also demonstrate the ability of the blending protocol to treat a wide range of off-spec gas mixture flow rates.

In a preferred embodiment, the dilution step involves introducing the H₂ balance gas directly into a recycle vessel, which contains the off-spec gases. The recycle vessel maintains the off-spec gases at pressures lower than the H₂ balance gas. As H₂ balance gas is fed into the recycle vessel, the pressure of the recycle vessel increases. When the dilution step is completed, the diluted off-spec mixture within the recycle vessel increases in pressure, as a result of the high-pressure H₂ balance gas being fed into the recycle vessel. At this stage, the high pressure diluted off-spec mixture can be discharged from the recycle vessel advantageously without assistance from a compressor or a venturi. The high pressure off-spec diluted mixture can be directed to a mixer where a mixture of pure PH₃ gas remixes with the diluted off-spec intermediate mixture to increase its concentration from 0.25% to the target 1% concentration, in accordance with step 2 of each of the Examples 13-16 of Table 4. Since the recycle vessel can be maintained at low pressure during normal operation when the method of diluting is used, this configuration allows the recycle vessel to be used as a collection vessel in which the gases from the blending system can be vented to the recycle vessel. As a result, a separate collection vessel 111, as shown in FIG. 1, is not required.

The concentration and flow rates set forth in the Examples 1-16 are intended to merely illustrate the protocol and wide applicability of the blending protocol to various process scenarios. Modifications are contemplated. For example, other flow rates and concentrations can be incorporated into the blending protocol. Further, the inventive blending protocol as described may consist of regulating with a mass flow controller or other flow control device a single gas stream, two gas streams or all of the gas streams. Additionally, although the examples above illustrate blending balance gas with a single active gas component, blending of two or more active gas components to respective target concentrations is also contemplated.

TABLE 4

| | | Example | Example | Example | Example |
|---|---|---|---|---|---|
| 2-Step Blending Protocol | | 13 | 14 | 15 | 16 |
| Concentration of PH₃ in off-spec | | 0.5% | 0.96% | 1.04% | 1.50% |
| mixture | | | | | |
| Step1: Dilute to 0.25% | Off-spec PH₃ | 60 | 39 | 29 | 20 |
| PH₃ | mixture (slpm) | | | | |
| | H₂ (slpm) | 60 | 88 | 92 | 100 |
| Step2: | .25% PH₃ | 99 | 99 | 99 | 99 |
| Concentrate to 1% | mixture (slpm) | | | | |
| PH₃ | PH₃ (slpm) | .75 | .75 | .75 | .75 |

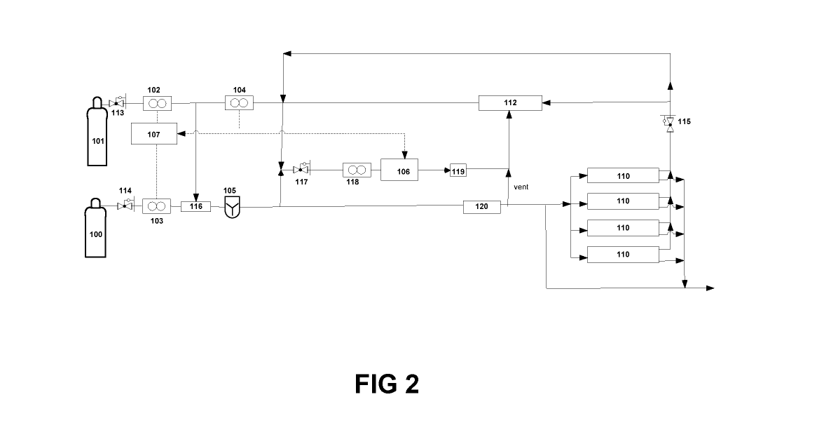

The inventive blending protocol as described in Tables 1-2 may be implemented with the dynamic gas blending process of FIG. 1 described above. Alternatively, another dynamic gas blending process as shown in FIG. 2 may be utilized to carry out the inventive blending protocol. As illustrated in FIG. 2, a venturi type device 116 is connected downstream of the mass flow controllers 102 and 103 of the corresponding gas sources 101 and 100. By using a venturi 116 and taking advantage of the higher pressure of the balance gas compared to that of the active gas, the low pressure active gas from gas source 101 can be mixed with the higher pressure balance gas from gas source 100 within the venturi 116. As shown in FIG. 2, the main inlet of the venturi 116 is connected to the balance gas source 100 supply. One of the openings of the venturi 116, which is shown facing upwards, is connected to the active gas source 101 as well as the recycled off-spec gas stream. The balance gas is supplied at a higher pressure and a higher flow rate. When the balance gas passes through venturi 116, it creates a low pressure around the upwardly-faced opening of the venturi 116 that is sufficient to suction the low pressure active gas from the active gas source 101 and off-spec gas from the recycle vessel 112 into the venturi 116. A compressor or other pressurized source to drive the active and off-spec gases is not required. Since the off-spec gas is able to be withdrawn from the recycle vessel 112 by the venturi 116, unlike the setup in FIG. 1, the recycle vessel 112 can be set to be the lowest pressure in the gas blending process of FIG. 2. Such a configuration enables gases from any part of the system to be vented to the recycle vessel 112. A back pressure control device 120 maintains a substantially constant pressure drop across venturi 116.

Still referring to FIG. 2, the active gas from gas source 101 and the recycle off-spec gas from recycle vessel 112 become mixed with the balance gas within the venturi 116. Mass flow controllers 102, 103 and 104 may regulate the flow rates of active gas, balance gas and recycle gas, respectively, in accordance with any of the embodiments of the inventive blending protocol described in Tables 1-4. An optional mixer 105 may be positioned downstream of the venturi 116 to further blend the gases.

The pressure of the resultant blended gas stream is higher than that of FIG. 1. As a result of the high pressure balance gas driving the mixing of the active and recycle gasses within venturi 116, gas analyzer 106 is positioned off line. This may allow the main supply lines to deliver gases over a wider range of flow rates and pressures than possible if using an on-line gas analyzer. FIG. 2 shows a bypass sample line downstream of mixer 105. The bypass sample line contains a pressure regulator 117 and a flow control device 118 which are used to control the pressure and flow rate of the sample blended gas mixture to the gas analyzer 106. The pressure regulator 117 and flow control device 118 are regulated to meet the requirements of the gas analyzer 106. An optional back pressure control device 119 may be positioned downstream of the gas analyzer 106 to further control the pressure across the analyzer 106 if variation of pressure affects the function of the analyzer 106.

The analyzer 106 monitors the concentration of the sample blended gas mixture. If the mixture is within specification, the resultant gas mixture may be sent to storage vessel 110 or downstream for further processing. Gas analyzer 106 sends a signal to controller 107, which then sends a signal to active gas mass flow controller 102 and/or balance gas mass flow controller 103 so that appropriate adjustments to the flow rates of active gas and balance from their respective gas sources 101 and 100 can be made. This feedback control loop procedure is repeated throughout the dynamic gas blending process to monitor the gas mixture and make adjustments to the mass flow controllers 102 and/or 103 as needed to ensure that the active gas concentration is within the acceptable concentration range. Accordingly, the mass flow controllers 102 and/or 103 are dynamically adjusted with a closed-loop feedback controller 107 that is capable of controlling blend accuracy of the active and source gases in real-time.

An optional additional venturi may be placed downstream of the back pressure control device 119 to extract the low pressure gases in the sample line to the main high pressure supply, thereby avoiding having to route the sample gas into a recycle vessel 112, as shown in FIG. 2. The optional venturi extracts the low pressure gases in the sample line into the main high pressure supply line. The extracted sample gases can thereafter be sent downstream if the gases are in specification.

As an alternative to withdrawing both the off-spec gas and the active gas using venturi 116 driven by the balance gas shown in FIG. 2, the venturi 116 may be used to only withdraw the off-spec gas from the recycle vessel 112 if the pressure of the active gas is sufficiently high to mix with the balance gas. In such an embodiment, the active gas may be directed downstream of the venturi 116 before entering the mixer 105 of FIG. 2.

The use of the venturi 116 of FIG. 2 is advantageous as it allows the active gas to be supplied at relatively low pressures or even sub-atmospheric pressures. This is advantageous because many active gases are toxic and therefore may need to be stored in its corresponding gas source 101 at low or sub-atmospheric pressures to prevent or reduce the gas emission in the event of a leakage from the active gas source 101. Furthermore, the vapor pressure of these toxic gases at ambient temperature is relatively low compared to balance gases. For example, the vapor pressure of PH₃ at 20° C. is about 600 psia. Therefore, the supply pressure of PH₃ has to be less than about 600 psia if no heating of the PH₃ is provided during delivery. The balance gas on the other hand is typically non-toxic and can therefore exert a pressure of a few thousand psig without risk of a toxic leak. As a result, the high pressure of the balance gas through the venturi 116 provides a suctioning effect into which the low pressure active gas and off-spec recycle gas streams can enter therein to provide mixing.

This configuration with the venturi 116 is also advantageous because it preserves the pressure energy of the high pressure balance gas to create sufficient blending of the gases even though the pressures of the active gas and off-spec gas are lower than that of the balance gas. The ability to maintain a lower set point pressure of the active gas source 101 may allow greater material utilization of the active gas.

Further, sufficient mixing can occur without using a compressor as shown in FIG. 1. The cost of the blending system without a compressor is much lower than with a compressor. Additionally, the blending system without using a compressor can reduce the possibility of contamination of the resultant product gas mixture that is sent to storage vessels 110 or downstream processing.

The dynamic gas blending process of FIG. 2 is configured similar to FIG. 1 to capture all waste and off-spec gas and convert it to product gas. Similar to FIG. 1, the dynamic gas blending system of FIG. 2 can be used to continuously supply and fill multiple vessels. Further, the ability to qualify the concentration of the gas mixture within a storage vessel 110 and adjust, if necessary, the concentration therewithin by recycling such gas, if necessary, assures that the concentration of the blended gas mixture being supplied downstream is within acceptable specification.

While it has been shown and described what is considered to be certain embodiments of the invention, it will, of course, be understood that various modifications and changes in form or detail can readily be made without departing from the spirit and scope of the invention. It is, therefore, intended that this invention not be limited to the exact form and detail herein shown and described, nor to anything less than the whole of the invention herein disclosed and hereinafter claimed.

1. A dynamic gas blending method for adjusting a concentration of an off-spec gas mixture to a target concentration, comprising the steps of:
recycling the off-spec gas mixture upstream of a mixer, wherein the off-spec gas mixture includes a gaseous component at an off-spec concentration;
regulating a flow rate of an active gas using a first flow control device, wherein the active gas includes the gaseous component at a concentration greater than the off-spec concentration;
regulating a flow rate of a balance gas using a second flow control device; and
re-blending the off-spec gas mixture with the active and the balance gases to create a resultant mixture at the target concentration.

2. The method of claim 1, wherein adjustments to the first flow control device or second flow control device are made in response to a feedback control loop.

3. The method of claim 1, wherein the regulated flow rates of the active gas and the balance gas are about equal to corresponding design flow rates of the active gas and the balance gas.

4. The method of claim 1, wherein the difference between the off-spec concentration and the target concentration is about 3% or lower.

5. The method of claim 1, wherein the step of blending comprises concentrating the off-spec concentration to the target concentration.

6. The method of claim 1, wherein the step of blending comprises diluting the off-spec gas concentration to the target concentration.

7. The method of claim 1, wherein the mixer is a venturi.

8. The method of claim 7, wherein the venturi withdraws at least one of the recycled off-spec gas and the active gas.

9. The method of claim 1, further comprising the steps of:
filling a first storage vessel with the resultant gas mixture; and
recycling off-spec gas from a second storage vessel upstream of the mixer to be re-blended with the active gas and the balance gas.

10. The method of claim 1, wherein all off-spec gas is routed to a recycle vessel.

11. A dynamic gas blending process comprising the steps of:
recycling the off-spec gas mixture upstream of a mixer at a recycled flow rate, wherein the off-spec gas mixture includes a gaseous component at an off-spec concentration;
regulating a flow rate of balance gas using a first flow control device;
re-blending the off-spec gas mixture with the balance gas;
diluting the off-spec gas mixture to a diluted concentration that is less than the off-spec concentration;
regulating a flow rate of active gas using a second flow control device, wherein the active gas includes the gaseous component at a concentration greater than the off-spec concentration; and
concentrating the off-spec gas mixture from the diluted concentration to the target concentration.

12. The method of claim 11, wherein the diluted off-spec gas mixture is discharged from the mixer without assistance of a compressor or a venturi to a second vessel for mixing with the active gas.

13. The method of claim 11, wherein adjustments to the first flow control device or second flow control device are made in response to a feedback control loop.

14. The method of claim 11, wherein the off-spec gas mixture is diluted to at least about 5% below the target concentration.

15. A dynamic gas blending method for adjusting a concentration of an off-spec gas mixture to a target concentration, comprising the steps of:
recycling the off-spec gas mixture upstream of a mixer, wherein the off-spec gas mixture comprises a gaseous component at an off-spec concentration;
regulating a flow rate of active gas using a first flow control device, wherein the active gas comprises the gaseous component at a concentration greater than the off-spec concentration;
re-blending the off-spec gas mixture with the active gas;
concentrating the off-spec gas mixture to a concentration that is greater than the off-spec concentration;
regulating a flow rate of balance gas using a second flow control device; and
diluting the off-spec gas mixture to the target concentration to create a resultant product mixture.

16. The method of claim 15, wherein the off-spec gas mixture is concentrated to at least about 5% above the target concentration.

17. The method of claim 15, wherein he regulated flow rates of the active gas and the balance gas are about equal to the corresponding design flow rates of the active gas and the balance gas.

18. The method of claim 15, further comprising the steps of:
qualifying the resultant product gas mixture from a first vessel that is filled;
sending a qualified product gas mixture from a second vessel for downstream processing; and
filling a third vessel with re-blended off-spec gas mixture.

19. The method of claim 15, wherein the off-spec gas mixture is recycled from a recycle vessel, a storage vessel, a collection vessel, or a combination thereof.

20. The method of claim 19, wherein the off-spec gas is suctioned into a venturi when the balance gas flows therethrough.
